(19) United States
(12) Patent Application Publication
(10) Pub. No.: US 2015/0142585 A1
(43) Pub. Date: May 21, 2015

(54) Internet affiliate network marketing system and method with associated computer program

(71) Applicant: Peter Scalise, Carmel-by-the Sea, CA (US)

(72) Inventor: Peter Scalise, Carmel-by-the Sea, CA (US)

(21) Appl. No.: 13/998,674

(22) Filed: Nov. 20, 2013

(51) Int. Cl. G06Q 30/02

(52) U.S. Cl. CPC G06Q 30/0277
USPC 705/14.73

(57) ABSTRACT

An Internet affiliate marketing method and associated computer program whereby a next generation affiliate network acts as an exchange for advertisers and merchants on one side and affiliates and next generation affiliates on the other. Affiliates and next generation affiliates sell content advertising in creatives to advertisers and merchants. Parties use this network to find each other, evaluate each other, and establish a purchase or advertising agreement using rewards. Creatives, using traditional advertising, familiar creative advertising, and combination advertising, are transmitted to the network website which posts them on selected social media sites. Parties accessing these sites are exposed to advertisers' and merchants' products appearing on creatives found therein. The network interfaces with enhanced capability supply-side platforms, real-time bidding platforms, and demand-side platforms that accommodate the new advertising concepts, familiar creative advertising and combination advertising.

### BACKGROUND OF THE INVENTION

1. Technical Field

The present invention generally relates to Internet marketing methods and systems and their associated computer programs. More particularly, the present invention relates to an Internet marketing method and its associated computer program that directs affiliate content in the form of advertising creatives to social media sites, supply-side platforms, real-time bidding platforms, and demand side platforms to advertise products and services

2. Background of the Prior Art

To better understand certain aspects of Internet advertising and marketing, the following descriptive definitions pertain to the description and operation of the present invention:

1. Internet surfer: Individual who is randomly or deliberately browsing or visiting any number of Internet websites.

2. Affiliate: Website or individual that supplies Internet advertising space through the use of an Affiliate Network. Affiliate is also a term referring to a promoter or a provider of one or more campaigns in an affiliate marketing network system.

3. Merchant: Seller of goods and/or services through Internet advertising methods.

4. Advertising Creative: A picture, animation, video, etc. used to advertise a product and/or service over the Internet. It is typically an image, text, HTML, email, etc. used by affiliates to drive traffic and sales to the merchant site. As they appear in the description of this invention, the terms Creative and Advertising Creative will both refer to the same thing: Advertising Creative.

5. Impressions: Another name for a view or an advertisement view; refers to the point in which an Internet advertisement is viewed once by a website visitor or displayed once on a website page.

6. Cost per Impression (“CPI”): The cost of Internet advertising and marketing campaigns whereby advertisers pay a fixed fee every time their advertisement is displayed. Due to the potentially large number of possible displays, the cost is typically referred to as Cost per Mille (“CPM”) or Cost per Thousand Impressions (“CPT”) whereby the advertising cost is computed as a fee for every one thousand impressions or displays.

7. Cost per Visitor (“CPV”): The cost of Internet advertising and marketing campaigns whereby advertisers pay for the delivery of a targeted visitor to the advertiser's website.

8. Cost per Click (“CPC”): The cost of Internet advertising and marketing campaigns whereby advertisers pay each time a user or surfer clicks on their listing and is redirected to the advertiser's website.

9. Cost per Action (“CPA”): The cost of Internet advertising and marketing campaigns whereby advertisement is performance based. The publisher takes the risk of running the advertisement and the advertiser pays only for the number of users that complete a transaction such as a purchase or a sign-up. This cost measures the advertiser's “per conversion cost” from start to finish. It measures how much it costs in advertising to convert one person from a visitor to a client for the company.

10. Supply Side Platform/Provider (“SSP”): An Internet entity used by Websites, Blogs, and Affiliates to manage and advertise their supply of Internet webpage space for advertising. The SSP is an electronic online advertising algorithmic platform that performs its functions in much the same way as a stockbroker in real life. The stockbroker sells a client's stock at the highest price it can obtain. Similarly, the SSB sells website inventory (advertising space) for the highest price possible on the Internet advertising market. The SSP typically provides a “dashboard” or control display for managing advertising space inventory and for reporting activity on a user's account.

11. Demand Side Platform/Provider (“DSP”): An Internet entity used by Advertisers such as Merchants and Advertising Agencies to manage Creative and advertisement campaigns. It is essentially an electronic system that allows digital advertisers to manage multiple advertisement exchange and data exchange accounts (advertising campaigns) through one interface (the advertising dashboard). Real time bidding for displaying online advertisements takes place within the advertising exchanges. By using the DSP, marketers can manage their bids for advertising space. Further, the DSP allows advertisers to optimize their advertisements based upon certain set “key performance indicators” such as “cost-per-clicks: and “costs per action.” Finally, DSPs typically provide a separate dashboard for managing advertising campaigns and reporting activity on a user's account.

12. Real Time Bidding Platform (“RTB”): An Internet entity that is an auction facility where a DSP electronically bids for advertising space offered by a SSP. An Internet user with advertising space available on his website visits a particular Internet website which causes that website to start loading information about that user. That website immediately sends out a bid request (generally through via SSP) to the RTB which queries the advertisers residing on the DSP if they would be interested in advertising on that Internet users website. The advertisers residing in the DSP respond much as bidders would respond at an auction. The RTB platform performs an instant online auction by accepting these bids from the advertisers (generally through the DSP) and then decides the winner.

13. Hyper-Targeting: Internet marketing to specific individuals.

14. Micro-marketing: Internet marketing to niche groups.

15. Familiar Advertising Creative: One of the innovative features of the present invention. Familiar Advertising Creative is the placement of Internet advertisements which feature members of the user's or the surfer's social network.

16. Combination Advertising: One of the innovative features of the present invention. Combination Advertising is the placement of Internet advertisements containing multiple products from multiple merchants or advertisers in a single creative.

17. Affiliate Marketing: Performance-based Internet marketing where a business or advertiser rewards one or more affiliates for each visitor or customer brought about by that affiliate's own marketing efforts.

18. Affiliate Marketing Network: This is a system used to co-brand, set up, track and pay advertisers and retailers for their referrals of end-users to the merchant's site and products.

19. Advertising Campaign: This refers to offerings which are made available to Affiliates by Advertisers. The advertising campaign typically contains a collection of creative and links for the purpose of driving traffic and sales to the merchant site. Campaigns may be configured to pay affiliates based on sales, clicks or leads.

The prior art contains examples of proposed systems and methods of arranging the advertisement over the Internet between advertisers and media owners. These methods and systems allow the advertisers to buy space from the media owners on a cost (pay)-per-click, cost (pay)-per-action, cost (pay)-per visitor, or cost (pay)-per-impression basis. The Internet advertisements contain a wide variety of campaigns generated by the advertisers designed to attract potential customers.

Internet advertising is a relatively new form of advertising and commercial promotion that uses the Internet and the World Wide Web to deliver marketing messages, product and service advertising, commercial promotion and solicitation, and the like to customers that have gained access to the Internet. Examples of Internet advertising include, without limitation: subject-matter specific (contextual) ads which are typically located and summarized by an Internet search engine, banner ads that appear on an individual Internet web site or web page, banner ads or hyperlinks that appear on an individual's blog, banner ads or hyperlinks that appear on individual or commercial social network sites, personal ads on social network sites or Internet sites promoting social interaction (such as Internet dating sites), online classified advertising, pop-up ads which are typically banner ads that spontaneously appear when a user visits a particular Internet web site or web page, Electronic-mail (E-mail) marketing, and advertising networks.

Initially, Internet marketing and advertising consisted of advertisers and merchants simply buying ad spaces on various Internet websites based on a site's general demographics. The advertisement was static and showed every visitor to that particular website the same ad in the same location. The solicitation for advertising space and the pricing for advertisements were based upon website activity (number of “hits' per given period of time) research and product similarity. By way of example, sporting goods manufacturers would likely try to place advertisements for their products on the websites owned by professional athletic teams. Similarly, merchants selling cookware would likely try to place advertisements for their products on the websites owned by television cooking shows. The negotiations for this form of manual advertisement placement were cumbersome and time-consuming which tended to make Internet advertising static as well as inefficient. Most websites executed their online advertising deals through a cumbersome process entailing back-and-forth of meetings, phone calls, e-mails and even faxes. Further, the fragmented market made it hard for ad agencies and brands to manage ad placement and updates.

In the meantime, other major industries already had automated sales systems. Concert arenas sold seats for various performances through an automated sales and tracking system. Similarly, airlines sold tickets through a collection of competing automated sales systems. Hotels offered rooms and restaurants handled reservations using automated sales and tracking systems. Eventually, Internet marketing and advertising followed suit with the creation of an automated marketplace for Internet websites to sell their inventory of advertising space. An early iteration of an automated marketplace consisted of an automated system for search ads. This was followed by an automated system for display advertisements, mobile advertisements, and video advertisements.

The manual advertising process and the early generation of the automated marketplace for Internet websites to sell their inventory of advertising space still constitute a significant portion of Internet marketing and advertising today. However, the automated marketplace has evolved into what is termed “real-time bidding” for advertising space on Internet websites. Complex algorithms are used to evaluate potential buyers, based on myriad data point such as the search terms entered into an Internet search engine, the Internet websites a potential buyer visits, the advertisements a potential buyer clicks on, and the like. Then, in real time, the chance to show that potential buyer an advertisement is electronically auctioned to the highest bidder.

Real-time bidding, an electronic trading system that sells advertising space on the Internet web pages people visit at the very moment they are visiting them. These electronic trading systems function in much the same way as a stock market; however, in this case, the market is only trading in audiences for online ads. These systems operate electronically and literally millions of bids flood in every second for advertising space on the website a visitor is visiting. Those bids will typically determine what particular advertisements a potential buyer will see when visiting any Internet website.

The bidders are advertisers and merchants seeking to identify their highest prospective buyers and place a targeted advertisement in front of those buyers before they move to the next internet web page or website. The system depends on data-mining to instantly evaluate the audiences available to see those online display advertisements that appear on Web sites next to or around content.

The current commercial model that handles this type of automated sales system of transactions involved with Internet advertising is shown in FIG. 1. Internet Websites 10 have a supply of advertising space to sell. Websites 10 are registered with a Supply Side Platform/Provider 20 (“SSP”). Websites 10 desiring to sell advertising space on one or more web pages in the Website 10 forward a solicitation to sell advertising space to the SSP 20 which collects and electronically manages and forwards these solicitations to sell to a Real Time Bidding Platform 30 (“RTB”). The SSP 20 manages the Website 10 inventory of advertising space to ensure that the Website 10 does not inadvertently sell more advertising space than it actually has. The SSP 20 also manages advertising space inventory so that advertising accounts for each Website 10 registered with the SSP 20 remain current.

The SSP 20 electronically directs the RTB 30 to commence an auction for advertising space offered by the Website(s) 10 and to provide Creatives 13 each time a page loads. The RTB 30 electronically notifies the Demand Side Platform/Provider 40 (“DSP”) that it has advertising space for sale, that an auction for advertising space is taking place, and that the space will be sold to the highest bidder registered with the DSP 40.

Numerous and various Advertisers 50 such as Merchants 51 and Advertising Agencies 52 are registered with the DSP 40 which acts as a type of agent for Advertisers 50 desiring advertising space on Internet Websites 10 and web pages. The DSP 40 manages each Advertiser's 50 demand for advertising space and automatically bid for advertising space when it becomes available using predetermined bidding criteria provided by the Advertiser(s) 50. If the advertising spaces offered by the Website 10 and the Website 10 itself are compatible with the needs of the Advertiser 50, the DSP 40 will electronically deliver a bid offer to the RTB 30. Typically, the DSP 40 will deliver bids from more than one Advertiser 50 with each bid priced according to bidding instructions provided by each separate Advertiser 50 to the DSP 40. The RTB 30 will then electronically transmit the bids to the SSP 20 which, in turn, transmits the bids to the Website 10 for selection.

The model depicted in FIG. 1 represents the brokering of advertising space on an Internet Website 10 where representatives of the Website 10 and representatives of the Advertiser 50 interact electronically to secure the advertising space offered by the Website 10 for one or more Advertisers 50. A certain commercial product, advertising space, is offered for sale by an offerer, the Website 10. A consumer, the Advertiser 50, purchases that product for an agreed upon sum of money. The transaction is a fundamental contractual agreement: an electronically transmitted offer to sell and an electronically transmitted purchase for agreed-upon consideration. The transaction is limited to an advertisement for one product from one Advertiser 50 which appears in one space on one Website 10.

Affiliate marketing is a specialized form of Internet or online advertising and marketing. Referring to FIG. 2, affiliate marketing relies upon a different transactional concept whereby special Websites 10 and Blogs 12 known as Affiliates 61, either or both having a supply of advertising space to sell, register for accounts on an Affiliate Network 60. At the same time, Advertisers 50 such as Merchants 51 and Advertising Agencies 52, either or both demanding advertising space, also register for accounts on that same Affiliate Network. Unlike the traditional model depicted in FIG. 1, Affiliate marketing contemplates both the seller and the buyer of advertising space to register on the same automated platform. The Affiliate Network 60 then acts as a venue for the Affiliates 61 and the Advertisers 50 to find one another and establish joint advertising campaigns.

Unlike the Advertisers 50 in the model depicted in FIG. 1, the Affiliates 61 do not pay a registration fee to register their Internet advertisements with the Affiliate Network 60. Instead, the Affiliates 61 only pay media fees to the Publishers 62 when commercial traffic to the Affiliate 61 is generated by the Affiliate Network 60 usually in the form of a registration by a Website 10 or Blog 12, a request for information, or an actual sale. The obvious advantage of affiliate marketing is that the Affiliate 61 does not pay advertising fees unless its advertising campaign generates or elicits some response from a potential transaction partner either selling advertising space or purchasing a product offered by the Affiliate 61.

In certain situations, the Affiliate Network 60 can interface with the marketing model depicted in FIG. 1. As with the model depicted in FIG. 1, other Websites 10 desiring to sell advertising space on one or more web pages in the Website 10 forward a solicitation to sell advertising space to the SSP 20 which collects and electronically forwards these solicitations to sell to the RTB 30. The RTB 30 electronically notifies the DSP 40 that it has advertising space for sale and that the space will be sold to the highest bidder registered with the DSP 40. Numerous and various Advertisers 50 are registered with the DSP 40 which acts as an agent for Advertisers 50 desiring advertising space on Internet web sites and web pages. As with the model depicted in FIG. 2, the Affiliate Network 60 also interacts with the DSP 40 in the same manner as an Advertiser 50.

If the Web Site 10 offering advertising space is compatible with the needs of the Advertiser 50 or the Affiliate Network 60, the DSP 40 will electronically deliver a bid offer to the RTB 30. Typically, the DSP 40 will deliver bids from more than one Advertiser 50 and/or Affiliate Network 60 with each bid priced according to bidding instructions provided by each separate Advertiser 50 and/or Affiliate Network 60 to the DSP 40. The RTB 30 will then electronically transmit the bids to the SSP 20 which, in turn, transmits the bids to the Web Site 10 for selection. Like the earlier system depicted in FIG. 1, this affiliate network system is limited to an advertisement for one product from one Advertiser 50 which appears in one space on one Website 10 every time a page loads.

While the models depicted in FIGS. 1 and 2, along with manual advertisement placement, represent a significant and substantial majority of the Internet marketing solutions available to commercial enterprises, they both have a significant shortcoming in that the advertisements registered by the Advertiser 50 with the DSP 40 and the advertisements posted by the Affiliate 61 with the Publisher 62 on the Affiliate Network 60, typically will only contain one product from one merchant per advertising picture. By way of example, an advertisement by a watch manufacturer will depict a model wearing a timepiece that is the subject of the entire advertisement. Similarly, an advertisement by a fashion designer will feature a model wearing the designer dress or sport coat that is the object of the entire advertisement.

The other items of clothing or accessories worn by the models such as shoes, slacks, accessories, ties, and the like are not addressed or highlighted by the advertisement. A viewer looking at that particular advertisement (for the watch or the designer dress or sport coat) may be interested in these other items but cannot obtain any relevant information about them because the watch manufacturer or fashion designer is paying to advertise its own products and not those of another enterprise. This forces the manufacturers of the “other” items to place similar, one-product-oriented advertisements to promote the shoes, the tie, the accessories, etc. As such, the design and operation of these Internet marketing models give rise to certain limitations. Specifically and without limitation:

1. The Internet marketing methods currently in operation and/or disclosed by the prior art typically contain one product per picture advertisement.

2. The Internet marketing methods currently in operation and/or disclosed by the prior art are typically limited to a single advertiser utilizing any given advertisement space on a given Internet webpage.

3. The Internet marketing methods currently in operation and/or disclosed by the prior art involve professionally created advertisements that are either created by the merchants or advertisers or by a professional advertising agency which drives up the cost of creating the advertisement while making the ad come across as removed and impersonal.

4. The Internet marketing methods currently in operation and/or disclosed by the prior art typically utilize the services of professional models or spokespersons to advertise their products and/or services which drives up the cost of creating the advertisement while making the ad come across as removed and impersonal.

5. The Internet marketing methods currently in operation and/or disclosed by the prior art do not contemplate incorporating a Creative provided directly from individual users in a free-style format.

6. The Internet marketing methods currently in operation and/or disclosed by the prior art typically do not contemplate using personal space on social media websites for Internet advertising.

7. The Internet marketing methods currently in operation and/or disclosed by the prior art do not contemplate the use of the Familiar Creative.

8. The Internet marketing methods currently in operation and/or disclosed by the prior art do not contemplate searching social media sites for products used by friends and family and visually selecting any desired products or services from the images contained in the Creatives posted therein.

9. The Internet marketing methods currently in operation and/or disclosed by the prior art do not contemplate searching social media sites for products used by friends and family, visually selecting any desired products or services from the images contained in the Creatives posted therein, and reading reviews about any selected products and or services by the individuals wearing, demonstrating, or otherwise promoting the desired items and/or services.

10. The Internet marketing methods currently in operation and/or disclosed by the prior art do not contemplate searching social media sites by motion picture, television program, celebrity name, and the like for products or services worn, demonstrated or otherwise promoted by individuals appearing in such media and then visually selecting the desired products and/or services from the images contained therein.

11. The Internet marketing methods currently in operation and/or disclosed by the prior art do not contemplate the use of Hyper-Targeting or Micro-Marketing.

12. The Internet marketing methods currently in operation and/or disclosed by the prior art do not contemplate the use of an entire screen image as advertising space.

13. The Internet marketing methods currently in operation and/or disclosed by the prior art do not contemplate using true branding by impression to identify desired products.

14. The Internet marketing methods currently in operation and/or disclosed by the prior art do not contemplate the use of a direct entry point for advertising to micro-communities of consumers who share an association through similar tastes in products and/or services.

15. The Internet marketing methods currently in operation and/or disclosed by the prior art do not contemplate using “synergistic advertisements.”

16. The Internet marketing methods currently in operation and/or disclosed by the prior art do not contemplate using an Affiliate Network that allows Affiliates to rate Merchants and vice versa.

17. The Internet marketing methods currently in operation and/or disclosed by the prior art do not contemplate allowing Affiliates to “team” together in a single image to increase advertising content in a single image by simply increasing the number of individuals advertising different products.

18. The Internet marketing methods currently in operation and/or disclosed by the prior art do not contemplate allowing Merchants to “team” together to promote multiple products in a single advertising campaign.

19. The Internet marketing methods currently in operation and/or disclosed by the prior art typically do not contemplate allowing an Advertiser to promote multiple products in a single advertising campaign.

3. Objects and Advantages.

The present invention seeks to overcome these shortcomings by providing an Internet Affiliate Marketing Method and Associated Computer Program that is backward compatible with existing systems, affordable, and easy to use while still addressing the aforementioned problems associated with the methods disclosed by the prior art. Accordingly, the objects and advantages of the present invention are:

(1) Providing an Internet affiliate marketing method and associated computer program that addresses and overcomes the problems associated with the methods and devices disclosed by the prior art.

(2) Providing an Internet affiliate marketing method and associated computer program based upon Hyper-Targeting or Micro-Marketing.

(3) Providing an Internet affiliate marketing method and associated computer program that eliminates the need for professional ad creation.

(4) Providing an Internet affiliate marketing method and associated computer program that eliminates mass appeal, not-targeted advertising on the Internet.

(5) Providing an Internet affiliate marketing method and associated computer program that uses a new approach to identify desired products by searching social media for products and visually selecting the desired items from the images contained therein.

(6) Providing an Internet affiliate marketing method and associated computer program that uses a new approach to identify desired products by searching social media by motion picture, television program, celebrity name, and the like for products and visually selecting the desired items from the images contained therein.

(7) Providing an Internet affiliate marketing method and associated computer program that uses a new approach, the “Familiar Advertising Creative,” to identify desired products by searching social media and the website hosting the computer program hosting the present invention for products used by friends and family and visually selecting the desired items from the images contained therein.

(8) Providing an Internet affiliate marketing method and associated computer program that uses a new approach to identify desired products by searching social media for products used by friends and family, visually selecting the desired items from the images contained therein, and reading reviews about the selected products from the individuals wearing the desired items.

(9) Providing an Internet affiliate marketing method and associated computer program that uses a new approach to identify desired products by turning the content of the images contained on various social media sites into advertising.

(10) Providing an Internet affiliate marketing method and associated computer program that uses a new approach to identify desired products by eliminating the need for overt advertising, screen covers, slide-ins, pop-ups, and the like.

(11) Providing an Internet affiliate marketing method and associated computer program that uses a new approach to multiple product advertising, the “Familiar Advertising Creative,” which serves (delivers) advertisements to Internet surfers featuring members of that surfer's social network wearing, using, or otherwise demonstrating products and/or services.

(12) Providing an Internet affiliate marketing method and associated computer program that uses a new approach to multiple product advertising using the entire screen for advertising space.

(13) Providing an Internet affiliate marketing method and associated computer program that uses a new approach to multiple product advertising that blends advertising and content so that the entire screen becomes advertising space.

(14) Providing an Internet affiliate marketing method and associated computer program that uses a new approach to identify desired products by personalizing Internet advertising.

(15) Providing an Internet affiliate marketing method and associated computer program that uses a new approach to identify desired products that offers true branding by impression.

(16) Providing an Internet affiliate marketing method and associated computer program that uses a new approach to identify desired products by providing a direct entry point for advertising to micro-communities of people who share an association by product use or taste.

(17) Providing an Internet affiliate marketing method and associated computer program that uses a new approach to identify effective Advertising Creatives through improved SSP, RTB, and DSP platforms.

(18) Providing an Internet affiliate marketing method and associated computer program that uses a new approach to identify desired products that will also lead to increased retail and on-line sales.

(19) Providing an Internet affiliate marketing method and associated computer program that uses a new approach to identify desired products that will also lead to increased traffic on social sites.

(20) Providing an Internet affiliate marketing method and associated computer program that uses a new approach to promote new advertising technologies that will, in turn, lead to a new industry using “synergistic advertisements.”

(21) Providing an Internet affiliate marketing method and associated computer program that uses a new approach to identify desired products that will also lead to a new industry for product identification and tagging for all sources of visual media on the Internet.

(22) Providing an Internet affiliate marketing method and associated computer program that uses a new approach to identify desired products that will also lead to the development of object recognition software.

(23) Providing an Internet affiliate marketing method and associated computer program that uses a new approach to identify desired products that will also drive the personal information verification market.

(24) Providing an Internet affiliate marketing method and associated computer program that uses a new approach to identify desired products that will also become a new factor for credit scores.

(25) Providing an Internet affiliate marketing method and associated computer program that uses a new approach to identify desired products by allowing affiliates to find desired merchants by product identification, merchant rewards and promotions, etc.

(26) Providing an Internet affiliate marketing method and associated computer program that uses a new approach to identify desired products that allows merchants to recruit affiliates.

(27) Providing an Internet affiliate marketing method and associated computer program that uses a new approach to identify desired products that allows affiliates to rate merchants and vice versa.

(28) Providing an Internet affiliate marketing method and associated computer program that uses a new approach to identify desired products that allows affiliates to “team” together in a single picture to increase the advertising content in a single visual image.

(29) Providing an Internet affiliate marketing method and associated computer program that uses a new approach to identify desired products that allows merchants to “team” together for an advertising campaign that will promote or advertise multiple products from more than one merchant in a single advertisement.

(30) Providing an Internet affiliate marketing method and associated computer program that uses a new approach to identify desired products that allows a single merchant to submit an advertising campaign that will promote or advertise multiple products from that merchant's inventory in a single advertisement.

(31) Providing an Internet affiliate marketing method and associated computer program that uses a new approach to identify desired products that will also provide affiliates and merchants a “dashboard” to manage reward programs, approvals, teaming, and the like.

(32) Providing an Internet affiliate marketing method and associated computer program that uses a new approach to identify desired products that will also provide unique SSP/RTB/DSP services for combination advertising as well as advertising using the “Advertising Familiar Creative.”

(33) Providing an Internet affiliate marketing method and associated computer program that provides the user with the ability to sort and filter products from advertisements according to configurable rules.

(34) Providing an Internet affiliate marketing method and associated computer program where the next generation Demand-Side Platform/Provider has the intelligence to include/exclude products according to configurable rules such as bidding limits for different Advertisers, conflicts between or among products appearing in the advertisement and the target site(s), synergies, and the like.

(35) Providing an Internet affiliate marketing method and associated computer program that is simple in design, easy and inexpensive to download, easy and safe to use, and commercially reasonable in price.

(36) Providing an Internet affiliate marketing method and associated computer program having a customized library that will identify and cross-reference advertisements contained in the affiliate network.

(37) Providing an Internet affiliate marketing method and associated computer program having an updated and enhanced SSP, RTB, and DSP platforms that incorporate new functionality to support Combination Advertising and Familiar Advertising Creative promotion.

(38) Providing an Internet affiliate marketing method and associated computer program with an updated and enhanced SSP that contains business rules and information regarding combinations of products that might appeal to a particular Internet surfer.

(39) Providing an Internet affiliate marketing method and associated computer program with an updated and enhanced SSP that creates a profile on an Internet surfer based upon clickstream and third party data and adds information from that surfer's social media connections to that profile so as to support the serving of Combination Ads and Familiar Advertising Creative to the advertising space of any Internet website.

(40) Providing an Internet affiliate marketing method and associated computer program with an updated and enhanced RTB that combines bids from multiple merchants and/or advertisers whose products appear on a single piece of Advertising Creative.

(40) Providing an Internet affiliate marketing method and associated computer program with an updated and enhanced RTB that combines bids from multiple merchants and/or advertisers whose products appear on a single piece of creative.

(41) Providing an Internet affiliate marketing method and associated computer program with an updated and enhanced RTB that by combining bids from multiple merchants and/or advertisers whose products appear on a single piece of creative, allows those advertisers and merchants to bid higher or lower based upon their perceived synergy of combinations of products, the improved user profile, and the weight of purchases made by social contacts, and the importance of the associate appearing in the advertisement.

(42) Providing an Internet affiliate marketing method and associated computer program with an updated and enhanced DSP that facilitates management and bidding algorithms for Combination Ads and Familiar Advertising Creative.

(43) Providing an Internet affiliate marketing method and associated computer program with an updated and enhanced SSP and DSP that enforce additional business rules for conflicting products.

(44) Providing an Internet affiliate marketing method and associated computer program with an updated and enhanced SSP and DSP that contain functionality to filter out information for products which will not be featured in an advertisement due to conflict, lack of bid from a particular merchant or advertiser, etc.

(43) Providing an Internet affiliate marketing method and associated computer program with an updated and enhanced SSP and DSP that will have the capability to generate synergistic advertisements by automatically examining the Internet surfer's profile and selecting combinations of products and social associates which appear in a single Advertising Creative in order to generate an advertisement with the highest impact on a potential purchaser.

Additional objects, advantages, and novel features of the invention will be set forth in part of the description which follows and will become apparent to those skilled in the art upon examination of the following specification, or will be learned through the practice of the present invention.

### DRAWINGS

FIG. 1 is a schematic diagram of the predominant Internet advertising model

FIG. 2 is a schematic diagram of an Affiliate Network advertising model

FIG. 3 is a schematic diagram depicting how the present invention functions as a Next-Generation Affiliate Network

FIG. 4 is a schematic diagram depicting how the present invention functions as a next generation Advertisement Server though interaction with the next generation of the Internet advertising model shown in FIG. 1

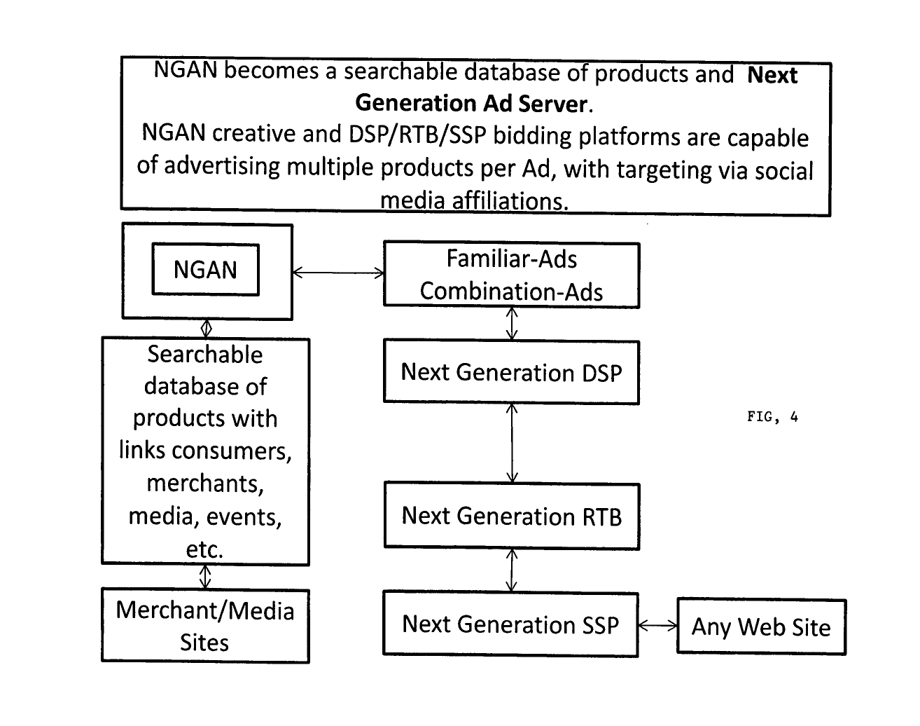

FIG. 5 is a schematic depicting merchant and affiliate registration with the NGAN

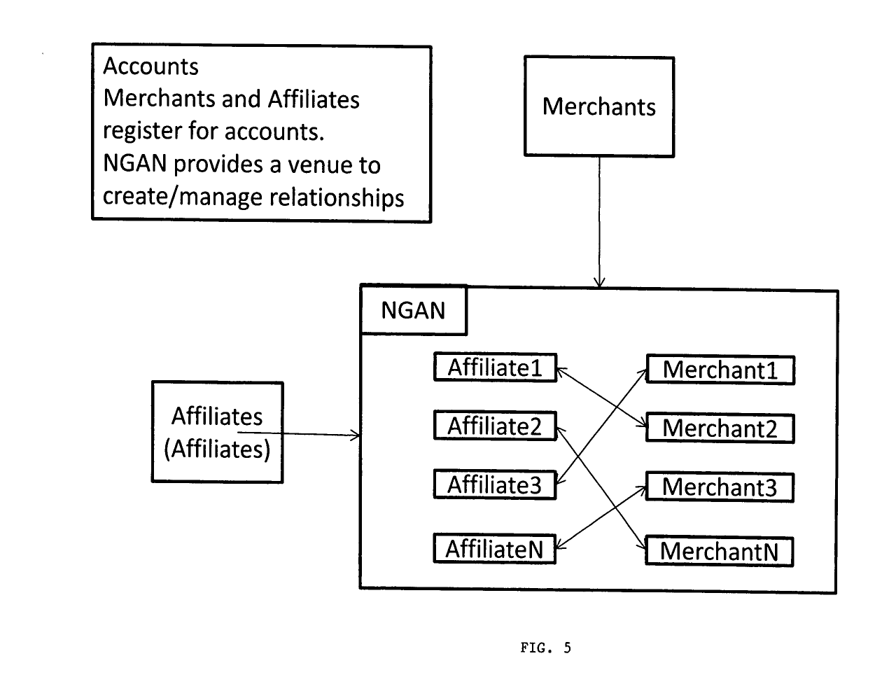

FIG. 6 is a schematic depicting NGAN management of merchant-to-merchant and affiliate-to-affiliate relationships

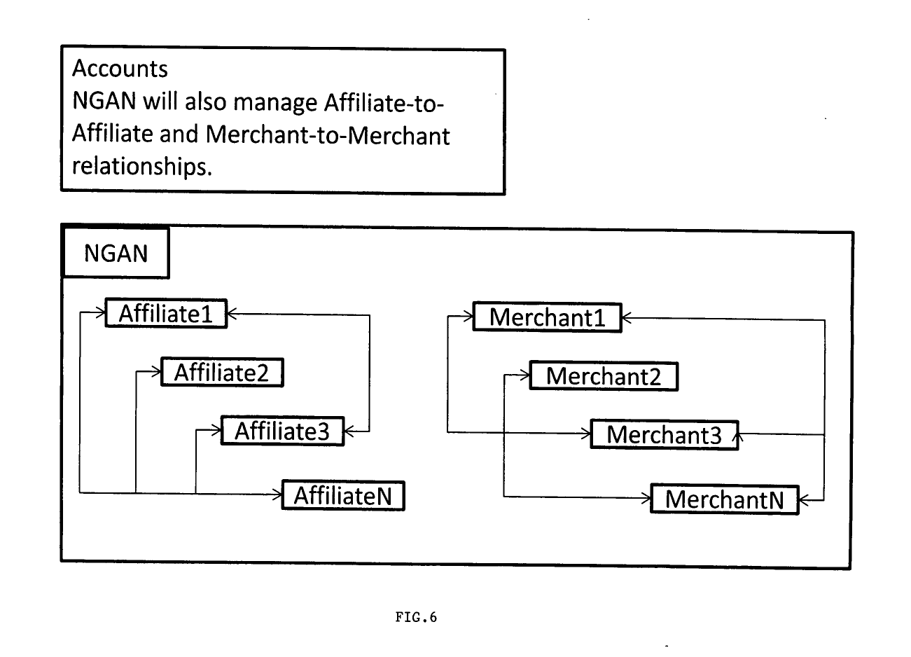

FIG. 7 is a schematic depicting input/output to/from the NGAN

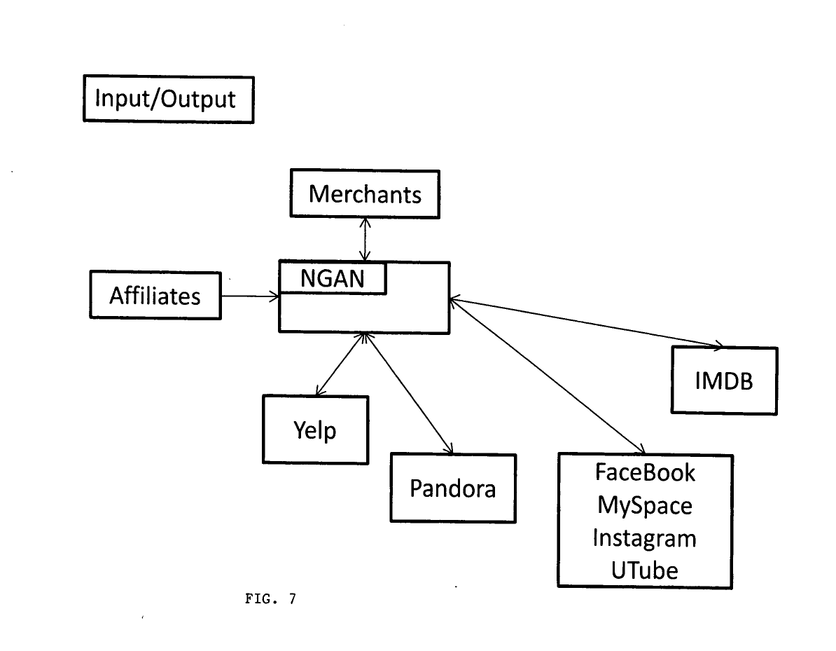

FIG. 8 is a schematic depicting the NGAN's bank of Creatives

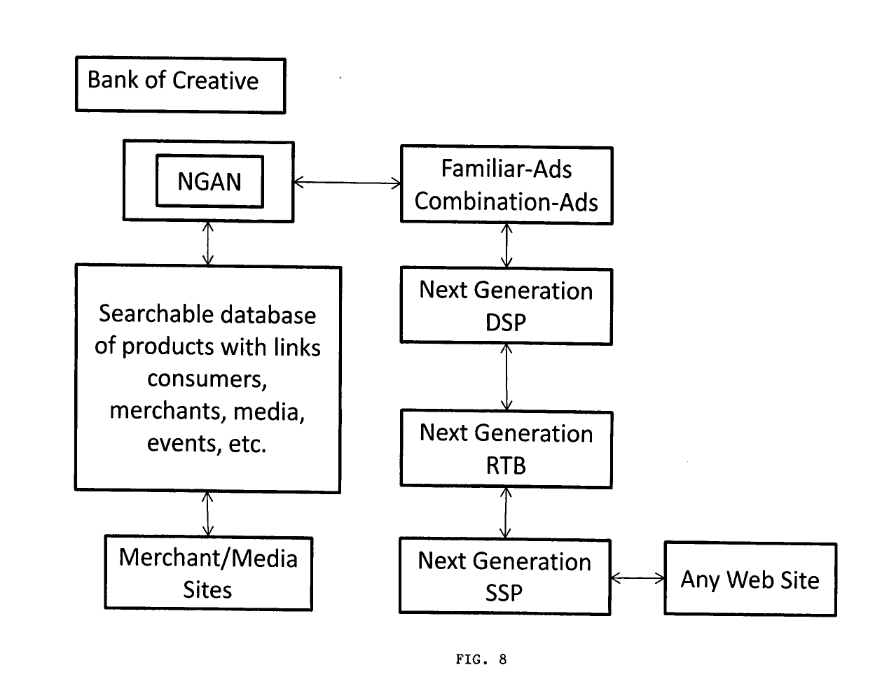

FIG. 9 is a schematic depicting site registration

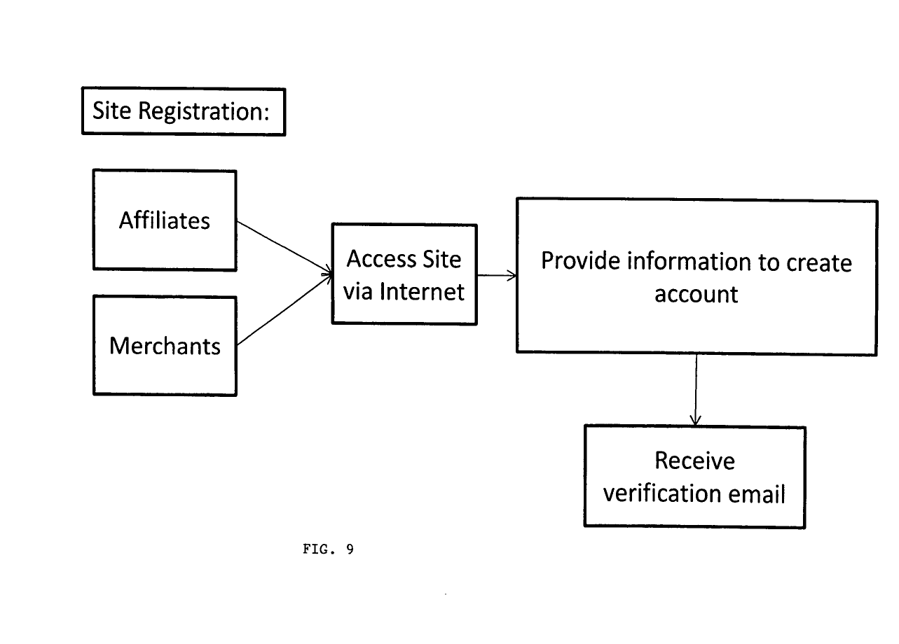

FIG. 10 is a schematic depicting the creation of a merchant reward program

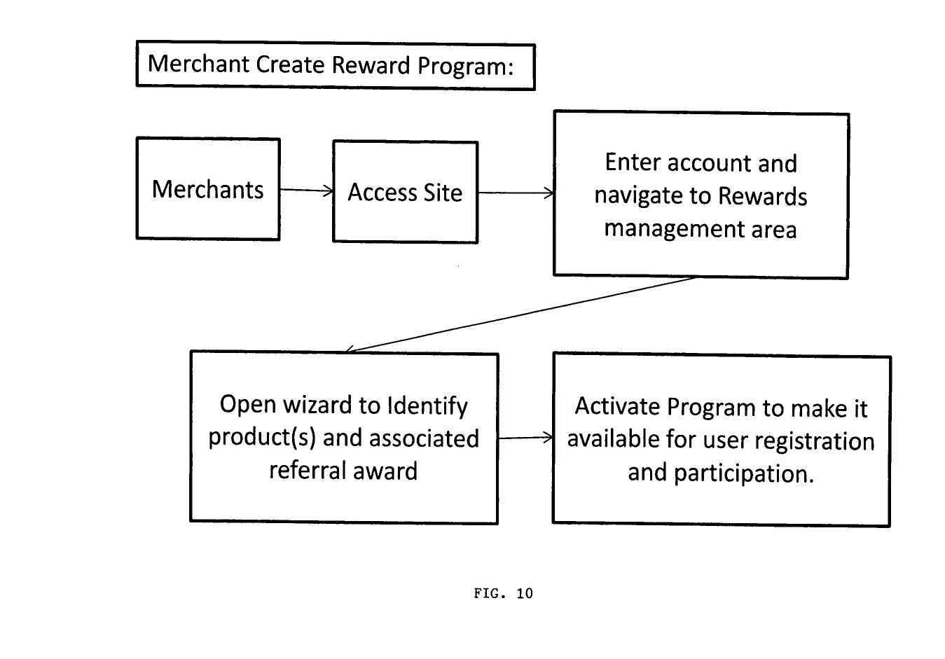

FIG. 11 is a schematic depicting how an affiliate adds a picture to its portfolio

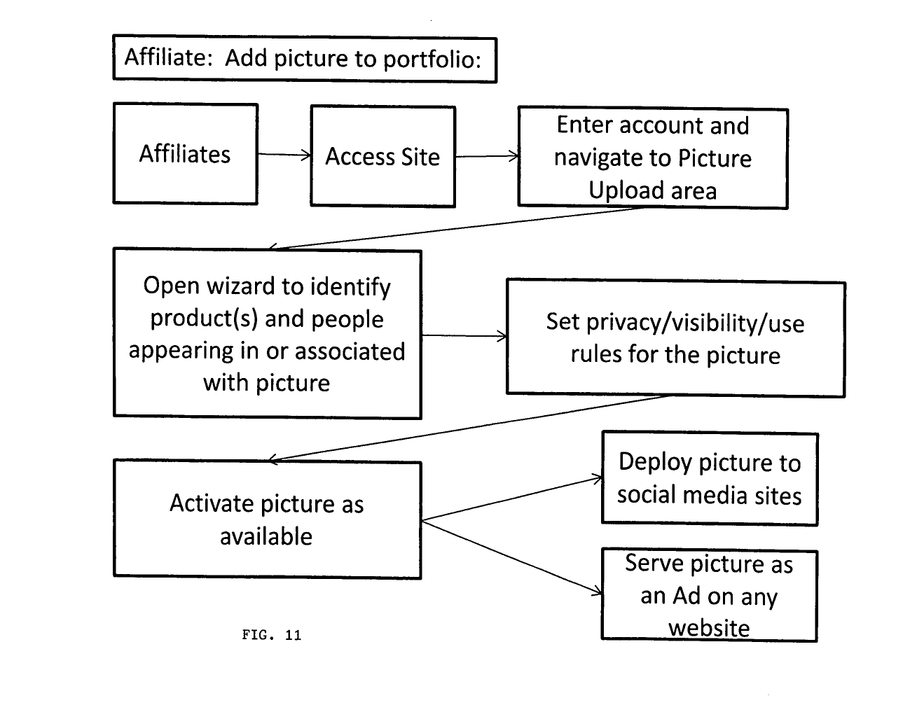

FIG. 12 is a schematic depicting how a Combination Ad is managed

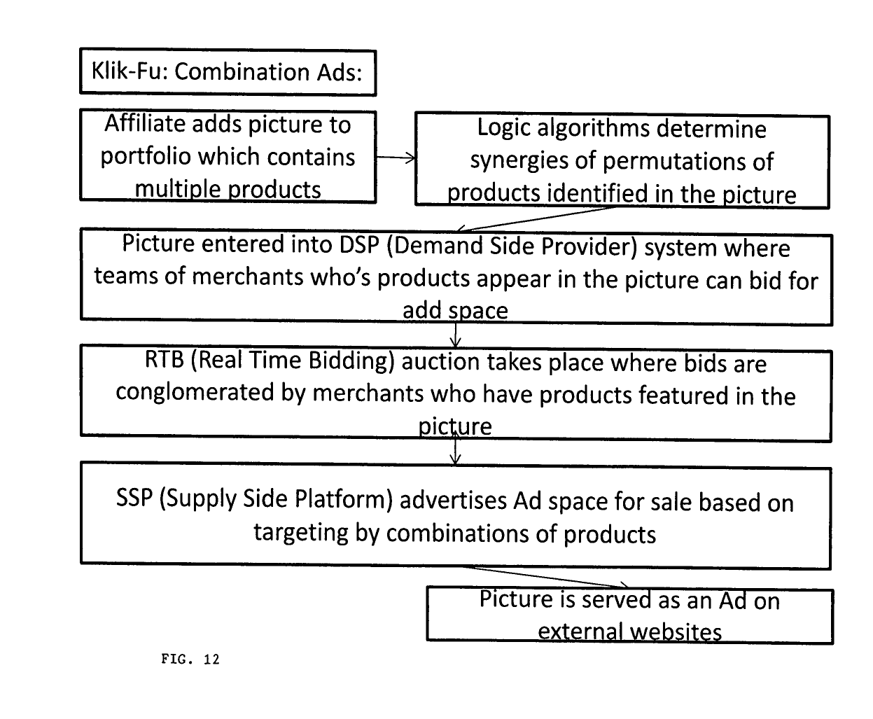

### DESCRIPTION OF THE INVENTION

### Reference Numerals

10—Website
11—Personal Website
110—Personal Website Owner
111—Friend of the Personal Website Owner
12—Blog
120—Blog Owner
13—Creative/Advertising Creative
131—Familiar Creative/Familiar Advertising Creative
14—Surfer
20—Supply Side Platform/Provider
201—Next Generation Supply Side Platform/Provider
30—Real-Time Bidding Platform
301—Next Generation Real-Time Bidding Platform
40—Demand Side Platform/Provider
401—Next Generation Demand Side Platform/Provider
50—Advertiser
51—Merchant
52—Advertising Agency
60—Affiliate Network
601—Next-Generation Affiliate Network
61—Affiliate
611—Next-Generation Affiliate
62—Publisher
63—Reward
64—Combination Advertisement
70—Social Media Site
80—Next-Generation Advertisement Server

### DESCRIPTION OF THE PREFERRED EMBODIMENT OF THE INVENTION

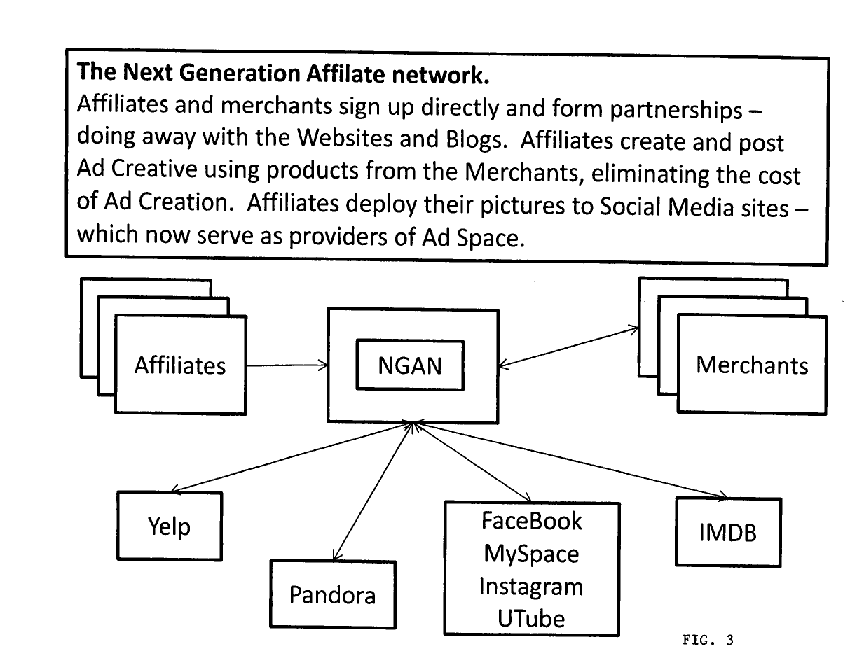

FIG. 3 is a schematic diagram of the present invention which should be viewed as an improved or next generation Affiliate Network 60. Next-Generation Affiliates 611 and Advertisers 50 such as Merchants 51 and Advertising Agencies 52 register directly with a Next-Generation Affiliate Network 601 to form advertising campaign partnerships between the Next-Generation Affiliates 611 and the Advertisers 50, thereby doing away with the need for Internet Websites 10, Personal Internet Websites 11, and Blogs 12 which rely upon the SSP 20 to forward their offer(s) of advertising space to the RTB 30. Similarly, Advertisers 50 register directly with the Next Generation Affiliate Network 601, thereby doing away with the need for Advertisers to rely upon the DSP 40 to forward its demand for advertising space to the RTB 30. Advertisers 50 use the Next-Generation Affiliate Network 601 to offer a series of Rewards 63 to Next-Generation Affiliates 611 for using that Merchant's 50 products or services in any Creative 13 posted by the Next-Generation Affiliate 611 with the Next-Generation Affiliate Network 601. The Next-Generation Affiliates 611 actually design and/or develop the Creatives 13 themselves which minimizes, and in many cases, eliminates the cost of creating advertisements. The Next-Generation Affiliates 611 also deploy their Creatives 13 directly to Social Media Sites 70 which now serve as providers of advertising space.

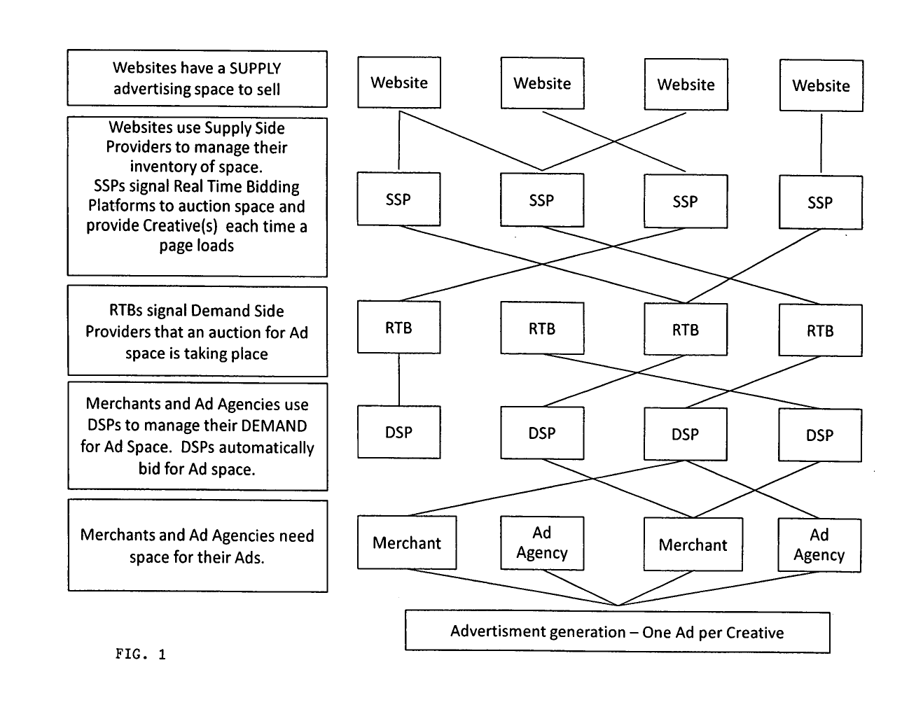

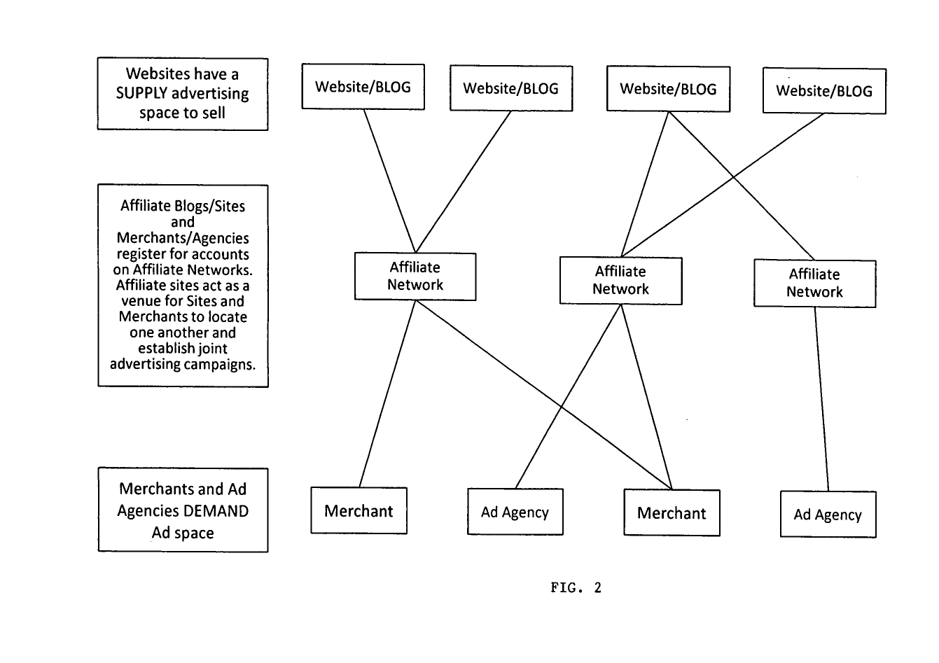

The Next-Generation Affiliate Network 601 relies upon a transactional concept that is similar to that used by the model depicted in FIG. 2. However, in the advertising model contemplated by the Next-Generation Affiliate Network 601, Next-Generation Affiliates 611 who are typically Personal Internet Website Owners 110 or Blog Owners 120 have already formed partnerships with Advertisers 50 and it is the Next-Generation Affiliates 611 that place advertising campaigns or Creatives 13 with Publishers 62 residing in the Next-Generation Affiliate Network 601. Further, unlike the Advertisers 50 in the model depicted in FIG. 1, the Next-Generation Affiliates 611 do not pay a registration fee to register their Creatives 13 with the Next-Generation Affiliate Network 601. Instead, the Advertisers 50 only pay media fees to the Publishers 62 when commercial traffic to the Advertiser 50 is generated by the Next-Generation Affiliate Network 601 usually in the form of a registration by a Website 10, a request for information, or an actual sale. When such commercial action is generated, the Advertiser 50 delivers a Reward 63 to the Next-Generation Affiliate 611 through the Next-Generation Affiliate Network 601.

As mentioned above, the Next-Generation Affiliate Network 601 also contemplates the incorporation of Social Media Sites 70 into its Internet marketing method. The Next-Generation Affiliate Network 601, in addition to storing the Advertising Creatives 13 posted by the Next-Generation Affiliates 611, will also forward those Advertising Creatives 13 to Social Media Sites 70 as per the instructions of each individual Next-Generation Affiliate 611. Any Surfer 14 visiting a Social Media Site 70 subscribed to by a Next-Generation Affiliate 611 can initiate commercial action such as a request for information, registration, or actual purchase of a product or service found in the Advertising Creative 13. In this manner, the Surfer 14 is generating commercial activity in the same manner as he or she would in the models depicted in FIGS. 1 and 2.

The major innovation of the model of Internet advertising taught by the present invention lies in the nature of the Advertising Creative 13 which is generally a photograph of the Personal Website Owner 110 or the Blog Owner 120 with or without Friends 111, 121. The Advertising Creatives 13 will feature these Owners and Friends 110, 120, 111, 121 sporting merchandise promoted by the Advertisers 50 thereby permitting several Advertisers 50 to “team up” and promote their merchandise in a single Internet advertisement. Any Surfer 14 visiting a Social Media Site 70 subscribed to by a Next-Generation Affiliate 611 can initiate commercial action such as a request for information, registration, or actual purchase of multiple products or services found in the Advertising Creative 13.

These Advertising Creatives 13 introduce a new concept in Internet advertising, that of Combination Advertising in which the placement of Internet advertisements containing multiple products from multiple merchants or advertisers in a single Advertising Creative 13 termed a Combination Advertisement 64. Combination Advertising represents a major improvement over the advertising found in the prior art and currently in use because it overcomes the drawback of advertisements being limited to one product from one merchant in a single advertising picture. Instead, through the use of Combination Advertisement 64 which the Advertising Creatives 13 contemplated by the present invention may and often do contain multiple products from multiple advertisers in a single advertising picture.

These Advertising Creatives 13 also introduce another new concept in Internet Advertising, that of the Familiar Advertising Creative 131 which use the placement of Internet advertisements featuring members of the Internet user's or the surfer's 14 social network. The Familiar Advertising Creative 131 represents another major improvement over the advertising found in the prior art and currently in use because it overcomes the impersonal and untouchable nature of current advertisements featuring professional models. The Familiar Advertising Creative 131 depicts a person known or familiar to the Internet user or Surfer 14 which establishes a type of personal bond between the user or Surfer 14 and the Familiar Advertising Creative 131, thereby increasing the likelihood that the Internet user or Surfer 14 will be interested in the products or services depicted in the Familiar Advertising Creative 131.

As with the model depicted in FIG. 2, the present invention relies upon a transaction whereby special Websites 10 and Blogs 12, now known as Next Generation Affiliates 611, either or both having a supply of advertising space to sell, register for accounts on an Affiliate Network 60. At the same time, Advertisers 50 such as Merchants 51 and Advertising Agencies 52, either or both demanding advertising space, also register for accounts on that same Affiliate Network. Again, unlike the traditional model depicted in FIG. 1, the Next Generation Affiliate Network 601 contemplates both the seller and the buyer of advertising space to register on the same automated platform. The Next Generation Affiliate Network 601 then acts as a venue for the Next Generation Affiliates 611 and the Advertisers 50 to find one another and establish joint advertising campaigns.

Unlike the Advertisers 50 in the model depicted in FIG. 1, the Next Generation Affiliates 611 do not pay a registration fee to register their Internet advertisements with the Next Generation Affiliate Network 601. Instead, the Next Generation Affiliates 611 only pay media fees to the Publishers 62 when commercial traffic to the Next Generation Affiliate 611 is generated by the Next Generation Affiliate Network 601 usually in the form of a registration by a Web Site 10, a request for information, or an actual sale. When such commercial action is generated by a Web Site 10, the Affiliate delivers a Reward 63 to the Personal Web Site 11 through the Next Generation Affiliate Network 601.

The preferred embodiment of the Next Generation Affiliate Network 601 contemplates interface with a Next Generation Supply Side Platform 201, a Next Generation Real-Time Bidding Platform 301, and a Next Generation Demand Side Platform 401. Accordingly, the Next Generation Affiliate Network 201 has the ability to electronically interface with the Next Generation SSP 201 that has the capability to (1) support both Combination Advertisements 64 and Familiar Creatives 131, and (2) profile Internet Surfers 14 based upon clickstream, third party data, and said surfer's 14 social media site 70 connections. The Next Generation Affiliate Network will also have the capability to serve Combination Advertisements 64 and Familiar Advertising Creative 131 advertising to the advertising space of any Internet Website 10, thereby functioning as a Next Generation Advertisement Server 80.

The Next Generation Affiliate Network will also have the capability to electronically interface with an enhanced, Next Generation RTB 301 having the capability to (1) support both Combination Advertisement 64 and Familiar Creative 131 Advertising, and (2) combine bids from multiple advertisers 50 whose products appear on a single piece of Advertising Creative 13. Finally, the Next Generation Affiliate Network will also have the capability to electronically interface with an enhanced Next Generation DSP 401 having a capability to (1) support both Combination Advertisements 64 and Familiar Creative 131 Advertising, and (2) facilitate management and bidding algorithms for Combination Advertisements 64 and Familiar Creative 131 Advertising.

### DESCRIPTION OF AN ALTERNATIVE EMBODIMENT OF THE INVENTION

In another embodiment of the present invention, The Next Generation Affiliate Network 601 has backward compatibility with the advertising model depicted in FIG. 1. As with the model depicted in FIG. 1, other Websites 10 desiring to sell advertising space on one or more web pages in the Website 10 forward a solicitation to sell advertising space to the SSP 20 which collects and electronically forwards these solicitations to sell to a RTB 30. The RTB 30 electronically notifies the DSP 40 that it has advertising space for sale and that the space will be sold to the highest bidder registered with the DSP 40. Numerous and various Advertisers 50 are registered with the DSP 40 which acts as an agent for Advertisers 50 desiring advertising space on Internet web sites and web pages.

As with the model depicted in FIG. 2, the Next Generation Affiliate Network 201 also interacts with the DSP 40 in the same manner as an Advertiser 50. However, because the SSP 10, RTB 20, and the DSP 40 have not been enhanced to receive or process Combination Advertisements 64 or Familiar Creative 131 advertising, the Creatives 13 posted by the Next Generation Affiliate Network 601 will likely be limited to more traditional advertisements.

If the Web Site 10 offering advertising space is compatible with the needs of the Advertiser 50 or the Next Generation Affiliate Network 601, the DSP 40 will electronically deliver a bid offer to the RTB 30. Typically, the DSP 40 will deliver bids from more than one Advertiser 50 and/or Next Generation Affiliate Network 601 with each bid priced according to bidding instructions provided by each separate Advertiser 50 and/or Next Generation Affiliate Network 601 to the DSP 40. The RTB 30 will then electronically transmit the bids to the SSP 20 which, in turn, transmits the bids to the Web Site 10 for selection.

### Operation of the Preferred Embodiment of the Invention

In its simplest embodiment the present invention, the Next Generation Affiliate Network 601 acts as an exchange for Advertisers 50 and Merchants 51 on one side and Affiliates 61 and Next Generation Affiliates 611 on the other side. The Affiliates 61 and Next Generation Affiliates 611 have something to sell which is content advertising in their respective Creatives 13. Advertisers 50 and Merchants 51 want to purchase the content advertising offered by Affiliates 61 and Next Generation Affiliates 611. All parties use the Next Generation Affiliate Network 601 to find each other, evaluate each other, and establish a purchase or advertising agreement through the use of Rewards 63.

Once the advertising agreement has been established and the Affiliates 61 and Next Generation Affiliates 611 have agreed to use the Advertisers' 50 and Merchants' 51 products in their Advertising Creatives 13, Familiar Advertising Creatives 131, or Combination Advertisements 64, the Affiliates 61 and Next Generation Affiliates 611 electronically transmit their Advertising Creatives 13, Familiar Advertising Creatives 131, or Combination Advertisements 64, the content of which now contains the Advertisers' 50 and Merchants' 51 products, to the Next Generation Affiliate Network 601, which then posts the Advertising Creatives 13, Familiar Advertising Creatives 131, or Combination Advertisements 64, on selected Social Media Sites 70. Any party such as a Surfer 14, another Affiliate 61, another Next Generation Affiliate 611, or a friend of the Affiliate 61 or Next Generation Affiliate 611 gaining access to any of the selected Social Media Sites 70 will be exposed to the Advertisers' 50 and Merchants' 51 products as they appear on the various Advertising Creatives 13, Familiar Advertising Creatives 131, or Combination Advertisements 64, found on those select Social Media Sites 70.

Affiliates 61 and Next Generation Affiliates 611 register and establish an account on the Next Generation Affiliate Network 601 is also linked to social media sites 70 used by the Affiliates 61 and Next Generation Affiliates 611. Affiliates 61 and Next Generation Affiliates 611 will post Advertising Creatives 13, Familiar Advertising Creatives 131, or Combination Advertisements 64, on the Next Generation Affiliate Network 601 which, in turn, posts them on selected Social Media Sites 70.

Similarly, Advertisers 50 and Merchants 51 register and establish an account to use the Next Generation Affiliate Network 601. Advertisers 50 and Merchants 51 use the Next Generation Affiliate Network 601 to offer Rewards 63 to Affiliates 61 and Next Generation Affiliates 611 for using, displaying, demonstrating, or otherwise advertising or marketing the Advertisers' 50 and/or Merchants' 51 products in their Advertising Creatives 13, Familiar Advertising Creatives 131, or Combination Advertisements 64.

Affiliates 61 and Next Generation Affiliates 611 will sign up for the Rewards 63 offered by the Advertisers 50 and/or Merchants 51 subject to the terms and conditions for using the Next Generation Affiliate Network 601. These Rewards 63 typically consist of incentives and programs such as cash, coupons or code, exclusive product offers, tickets and passes, airline miles, hotel and rental car award points, special requests tailored to a specific Affiliate 61 or Next Generation Affiliate 611, and the like. Advertisers 50 and Merchants 51 can then use the Next Generation Affiliate Network 601 to screen and approve or disapprove the requests for Rewards 63 submitted to the Next Generation Affiliate Network 601 by the Affiliates 61 and the Next Generation Affiliates 611.

The Next Generation Affiliate Network 601, which is managed according to a computer program detailing the process disclosed by the present invention, provides a search feature allowing Merchants to recruit Affiliates. Similarly, the Next Generation Affiliate Network 601 provides a search feature allowing Affiliates 61 and Next Generation Affiliates 611 to find Merchants 50 by matching a desired product, reward, etc. with the appropriate Merchant(s) 50. The Next Generation Affiliate Network 601 also provides a rating feature that allows Merchants 50 to rate Affiliates 61 and Next Generation Affiliates 611 and vice versa.

A registered Affiliate 61 or Next Generation Affiliate 611 then posts one or more pictures in their account. The Affiliate 61 or Next Generation Affiliate 611 activates the site's “wizard” function to “tag” or identify various products in the pictures posted in his/her account. After the desired products have been “tagged” the Next Generation Affiliate Network 601 then deploys the pictures to various social media sites 70, a Next Generation Demand Side Platform 401, or a particular, targeted Internet Website 10.

### Other Applications of the Present Invention

While the present invention offers numerous advantages over Internet marketing programs found in the prior art, its innovative features have applications that can be applied to other marketing schemes. Specifically:

(1) Retail merchandise is typically marketed and distributed regionally in numbered (bar-coded) lots or batches. The shipping, sales and product recalls of such merchandise is usually tracked by these lot or batch numbers. Manufacturers can access Creatives 13 stored in the Next Generation Affiliate Network 601 and marry them to specific region and/or product demographics and use a Creative 13 associated with that specific region and/or product demographic as part of the product packaging.

(2) The Advertising Creatives 13 stored in the Next Generation Affiliate Network 601 can also be used in direct marketing campaigns. The Advertising Creative 13 would be categorized and gathered by geographic location (city, town, neighborhood, school, etc.) as well as by social network origin and then printed in lots that would ultimately be directed to each of those respective geographic locations or social network origins. This application provides community-oriented consumer-generated content that is directed to a specific geographic region.

(3) The FB Graph Search statistics generated by the Next Generation Affiliate Network 601 could be sold to merchant subscribers to determine or otherwise formulate their target demographic.

### SUMMARY

In summary, the present invention, this Next Generation Affiliate Network (“NGAN”) provides the following advantages over the methods and systems disclosed by the prior art:

(1) The NGAN takes advantage of hyper-targeting and micro-marketing. It provides and unprecedented level of detail and combines it with a social dimension to creative advertising that is familiar or personal to a potential Consumer such as an Internet Surfer 14, a Personal Website Owner 110, the Friend of an Internet Website Owner 111, an Affiliate 61, or a Next Generation Affiliate 611.

(2) NGAN reduces the need for professional ad creation and eliminates attempts at mass-appeal, non-targeted ads. It represents a new dimension in both viral and affiliate advertising.

(3) NGAN offers an entirely new method of identifying products by allowing Internet and social media users to shop by:
(a) searching social media for products
(b) seeing what type of people are using what products and services (especially friends and family)
(c) reading reviews of products and services from people known to the user
(d) searching movies, TV shows, and actors/characters to find products thereby offering an entirely new dimension for product positioning and movie/TV advertising.

(4) NGAN turns content into advertising. Since the content is melding with the advertising, visitors will want to look at the ads instead of avoiding them.

(5) NGAN personalizes ads and offers true branding by impression. Seeing an associate, friend, family member, etc. using a product or service gives the user immediate association with that product or service.

(6) NGAN makes shopping for someone known to the user easier. The user can simply use NGAN check out the profile, tastes, style preferences, etc. of an associate, friend, family member etc. and make his/her purchases accordingly.

(7) NGAN capitalizes on social media personalized advertisements.

(8) NGAN introduces the multi-product Creative whereby multiple products are advertised in a single advertisement.

(9) NGAN introduces the next-generation SSP, RTB, and DSP.

What is claimed is:

1. An Internet Affiliate Network Marketing Method comprising the following steps:
a. One or more advertisers creating an account to electronically use said affiliate network,
b. One or more affiliates creating an account to electronically use said affiliate network,
c. Said Advertisers creating reward programs to entice said affiliates to develop advertising creatives to showcase products and services sponsored or promoted by said advertiser on said affiliates websites, blogs or social media site,
d. Said advertisers electronically posting said reward programs through said account on said affiliate network,
e. Said affiliate network establishing an electronic link on the Internet between each of said affiliate's said accounts and one or more social networking sites respectively subscribed to by each of said affiliates,
f. Said affiliate network providing a search capability for said affiliates to locate said advertisers by product, service, reward, and/or any other such feature unique to said Advertiser,
g. Said affiliate network providing a different search capability for said advertisers to recruit said affiliates to advertise said advertisers' respective products and/or services,
h. Said affiliate network providing a means for establishing an advertising agreement between said affiliates and said advertisers,
i. Said affiliates individually or jointly generating advertising creatives containing products or services promoted by said advertisers,
j. Said affiliate network providing said affiliates a capability to individually or jointly display said Creatives on private space located on each of said affiliates' websites, blogs, and/or social networking sites,
k. Said affiliate network providing more than one of said advertisers an ability to collectively advertise multiple products in said creative,
l. Said affiliate network providing each of said advertisers with a capability to individually advertise multiple products in said creative,
m. Said affiliate network providing said Affiliates with a capability of tagging or otherwise identifying products and/or services depicted in said creatives,
n. Said affiliate network providing Internet surfers with access to said creatives found on said affiliates' social networking site,
o. Said affiliate network providing surfers with an ability to electronically identify and select desired products and services pictured in said Creatives, and
p. Said affiliate network reading said electronic identification and selection and electronically directing said Surfers to Internet websites maintained by Advertisers promoting said electronically identified and selected products.

2. The Internet Affiliate Marketing Method described in claim 1 further comprising the following additional steps:
a. Said affiliate network providing said affiliates a capability to rate said Advertisers,
b. Said affiliate network providing advertisers a capability to rate said affiliates,
c. Said affiliate network providing both said affiliates and said advertisers with privacy and information access,
d. Said affiliate network providing said affiliates and said advertisers with a capability to avoid conflicts of advertisements in said creatives,
e. Said affiliate network providing said affiliates and said advertisers with a capability to control placement of said creatives in appropriate Internet websites,
f. Said affiliate network providing said affiliates and said advertisers with rule-based filtering to avoid said conflicts and control said placement,
g. Said affiliate network providing said affiliates and said advertisers with team agreements to avoid said conflicts and control said placement,
h. Said affiliate network providing said advertisers with a dashboard capability to manage reward programs, said affiliates, approval or disapproval of said affiliates, overall advertising traffic, teaming arrangements and the like,
i. Said affiliate network providing said affiliates with a dashboard capability to manage rewards, picture images, overall advertising traffic, teaming arrangements and the like,
j. Said affiliate network providing said affiliates with end-to-end click through services for said creatives,
k. Said affiliate network providing said affiliates and said Advertisers with an interface for serving any of said affiliate's said creatives to any Internet website,
l. Said affiliate network providing a stream of said creative data to next-generation SSP/RTB/DSP services for combination advertising, bidding, management of supply-side advertising space, management of demand-side advertising space, management of placement of said creatives in a bidding space.
m. Said affiliate network providing said affiliates and said advertisers with a capability to gather, store, and organize said affiliate information for Micro-Marketing,
n. Said affiliate network providing said affiliates and said advertisers with a capability to utilize Familiar Advertising,
d. Said affiliate network serving said creatives posted by said affiliates into any Internet website visited by said surfer, and
e. Said affiliate network providing said Affiliates and said Advertisers with a search interface for product posted in any of said Affiliate's said Creatives.

3. The computer-implemented Internet Affiliate Marketing Method in claim 1 further comprising the following additional steps:
a. electronically interfacing with an enhanced SSP having a capability to (1) support both Combination Advertising and Familiar Creative Advertising, and (2) profile Internet surfers based upon clickstream, third party data, and said surfer's social media connections, and
b. serving said Combination Advertising and said Familiar Creative advertising to advertising space of any Internet website.

4. The computer-implemented Internet Affiliate Marketing Method in claim 1 further comprising the following additional step: electronically interfacing with an enhanced RTB having a capability to (1) support both Combination Advertising and Familiar Creative Advertising, and (2) combine bids from multiple advertisers whose products appear on a single piece of creative.

5. The computer-implemented Internet Affiliate Marketing Method in claim 1 further comprising the following additional step: electronically interfacing with an enhanced DSP having a capability to (1) support both Combination Advertising and Familiar Creative Advertising, and (2) facilitate management and bidding algorithms for said Combination Advertising and said Familiar Creative Advertising.

6. The computer-implemented Internet Affiliate Marketing Method in claim 1 further comprising the following additional steps:
a. electronically interfacing with an enhanced SSP having a capability to (1) support both Combination Advertising and Familiar Creative Advertising, and (2) profile Internet surfers based upon clickstream, third party data, and said surfer's social media connections,
b. serving said Combination Advertising and said Familiar Creative advertising to advertising space of any Internet website,
c. electronically interfacing with an enhanced RTB having a capability to (1) support both Combination Advertising and Familiar Creative Advertising, and (2) combine bids from multiple advertisers whose products appear on a single piece of creative, and
d. electronically interfacing with an enhanced DSP having a capability to (1) support both Combination Advertising and Familiar Creative Advertising, and (2) facilitate management and bidding algorithms for said Combination Advertising and said Familiar Creative Advertising.

7. A computer program executing the method of claim 1 and all of its dependent claims comprising:
a. A function to allow one or more Affiliates to register to use a Next Generation Affiliate Network,
b. A function to allow said Affiliates to also establish an account on said Next Generation Affiliate Network,
c. A function to allow said Next Generation Affiliate Network to establish an electronic link on the Internet between each of said Affiliate's said accounts and one or more social networking sites respectively subscribed to by each of said Affiliates,
d. A function to allow one or more Advertisers to register to use said Next Generation Affiliate Network,
e. A function to allow said Advertisers to offer rewards through an awards program containing terms and conditions and an approval process to said Affiliates on said Next Generation Affiliate Network for advertising said Advertiser's products or services,
f. A function to allow said Affiliates to sign up for said rewards pursuant to said terms and conditions of said rewards program and said approval process,
g. A function to allow said Next Generation Affiliate Network to provide a search capability for Said Affiliates to locate said Advertisers by product, service, reward, and/or any other such feature unique to said Advertiser,
h. A function to allow said Next Generation Affiliate Network to provide a search capability for said Advertisers to recruit said Affiliates to advertise said Advertisers' respective products and/or services,
i. A function to allow said Next Generation Affiliate Network to provide said Affiliates a capability to rate said Advertisers,
j. A function to allow said Next Generation Affiliate Network to provide Advertisers a capability to rate said Affiliates,
k. A function to allow said Affiliates to individually or jointly generate Creatives containing products or services promoted by said Advertisers,
l. A function to allow said Next Generation Affiliate Network to provide said Affiliates a capability to individually or jointly display said Creatives on private space located on each of said Affiliates' social networking sites,
m. A function to allow said Next Generation Affiliate Network to provide more than one of said Advertisers an ability to collectively advertise multiple products in said Creative,
n. A function to allow said Next Generation Affiliate Network to provide each of said Advertisers with a capability to individually advertise multiple products in said Creative,
m. A function to allow said Next Generation Affiliate Network to provide both said Affiliates and said Advertisers with privacy and information access,
n. A function to allow said Next Generation Affiliate Network to provide said Affiliates with a capability of tagging or otherwise identifying products and/or services depicted in said Creatives,
o. A function to allow said Next Generation Affiliate Network to provide Internet Surfers with access to said Creatives found on said Affiliates' social networking site,
p. A function to allow said Next Generation Affiliate Network to provide Surfers with an ability to electronically identify and select desired products and services pictured in said Creatives,
q. A function to allow said Next Generation Affiliate Network to read said electronic identification and selection and electronically directing said Surfers to Internet websites maintained by Advertisers promoting said electronically identified and selected products,
r. A function to allow said Next Generation Affiliate Network to provide said Affiliates and said Merchants with a capability to avoid conflicts of advertisements in said Creatives,
s. A function to allow said Next Generation Affiliate Network to provide said Affiliates and said Merchants with a capability to control placement of said Creatives in appropriate Internet websites,
t. A function to allow said Next Generation Affiliate Network to provide said Affiliates and said Merchants with rule-based filtering to avoid said conflicts and control said placement,
u. A function to allow said Next Generation Affiliate Network to provide said Affiliates and said Merchants with team agreements to avoid said conflicts and control said placement,
v. A function to allow said Next Generation Affiliate Network to provide said Advertisers with a dashboard capability to manage reward programs, said Affiliates, approval or disapproval of said Affiliates, overall advertising traffic, teaming arrangements and the like,
w. A function to allow said Next Generation Affiliate Network to provide said Affiliates with a dashboard capability to manage rewards, picture images, overall advertising traffic, teaming arrangements and the like,
x. A function to allow said Next Generation Affiliate Network to provide said Affiliates with end-to-end click through services for said Creatives,
y. A function to allow said Next Generation Affiliate Network to provide said Affiliates and said Advertisers with an interface for serving any of said Affiliate's said Creatives to any Internet website,
z. A function to allow said Next Generation Affiliate Network to provide a stream of said Creative data to next-generation SSP/RTB/DSP services for combination advertising, bidding, management of supply-side advertising space, management of demand-side advertising space, management of placement of said Creatives in a bidding space,
aa. A function to allow said Next Generation Affiliate Network to provide said Affiliates and said Advertisers with a capability to gather, store, and organize said Affiliate information for Micro-Marketing,
bb. A function to allow said Next Generation Affiliate Network to provide said Affiliates and said Advertisers with a capability to utilize Familiar Advertising,
cc. A function to allow said Next Generation Affiliate Network to serve said Creatives posted by said Affiliates into any Internet website visited by said Surfer, and
dd. A function to allow said Next Generation Affiliate Network to provide said Affiliates and said Advertisers with a search interface for product posted in any of said Affiliate's said Creatives.
